(19) United States
(12) Patent Application Publication
(10) Pub. No.: US 2023/0008268 A1
(43) Pub. Date: Jan. 12, 2023

(54) EXTRAPOLATED USAGE DATA

(71) Applicant: Hewlett-Packard Development Company, L.P., Spring, TX (US)

(72) Inventors: Shiva BANSAL, Pune (IN); Vivek BIRADAR, Pune (IN); Manohar Lal KALWANI, Pune (IN); Vaibhav TARANGE, Pune (IN); Abhisarika VERMA, Pune (IN); Ayesha AKTER, Palo Alto, CA (US)

(21) Appl. No.: 17/858,718

(22) Filed: Jul. 6, 2022

(30) Foreign Application Priority Data
Jul. 7, 2021 (IN) 202141030494

(51) Int. Cl. G06N 5/02

(52) U.S. Cl. CPC G06N 5/022

(57) ABSTRACT

In an example in accordance with the present disclosure, a system is described. The system includes a data collector to collect usage data for the electronic device over a first period of time. The system also includes a model generator. The model generator extrapolates usage data for the electronic device over a second period of time that is longer than the first period of time and predicts a state of the electronic device based on extrapolated usage data for the electronic device over the second period of time.

### BACKGROUND

Electronic devices are used by millions of people daily to carry out business, personal, and social operations. Examples of electronic devices include desktop computers, laptop computers, all-in-one devices, tablets, smartphones, wearable smart devices, and gaming systems to name a few.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a system for extrapolating usage data, according to an example of the principles described herein.

FIG. 2 illustrates usage data extrapolated based on observed usage data, according to an example of the principles described herein.

FIG. 3 is a flowchart of a method for extrapolating usage data, according to an example of the principles described herein.

FIG. 4 is a diagram of a system for extrapolating usage data, according to an example of the principles described herein.

FIG. 5 is a diagram of a system for extrapolating usage data, according to an example of the principles described herein.

FIG. 6 is a flowchart of a method for extrapolating usage data, according to an example of the principles described herein.

FIG. 7 depicts a non-transitory machine-readable storage medium for extrapolating, usage data, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Electronic devices have become widespread in today's society and it is not uncommon for an individual to interact with multiple electronic devices on a daily basis. Electronic devices include any number of hardware components to carry out their intended functionality. For example, electronic devices may include batteries, processors, memory devices, transistors, resistors, fans, and any number of other hardware components as well as circuitry to connect these and other hardware components. While it is inarguable that electronic devices have widespread use, certain characteristics of electronic devices may impede their more complete integration.

For example, over time, the performance of each of these hardware components may decline. In certain cases, hardware components may completely fail. In yet another example, the hardware components may become outdated, such that the hardware component should be replaced or updated. Hardware component failure is difficult to predict and an unexpected failure may have undesirable consequences. For example, failure of a hard drive, if not accounted for, may result in irretrievable data loss and may also result in reduced productivity as the hardware component is replaced and or repaired. Such an effect is exacerbated in environments, such as a large organization, where there are hundreds of electronic devices, each of which have dozens of hardware components that may fail at any point in time. While one particular consequence of hardware component failure is described, a variety of other failure mechanisms may similarly result in a costly and inefficient remedial process.

Accordingly, the present specification describes a method for predicting a state of an electronic device, such that preventative measures may be taken before a remedial measure is called for. Specifically, the present specification describes a data collector that collects usage data of the electronic device and the hardware components therein. A model generator then predicts the state of the electronic device based on collected usage data.

However, for accurate prediction, historical data for a certain period of time may be desired. For example, accurate predictions of a state of an electronic device may be based on usage data collected over a 6-month period. However, it may be that usage data over this period of time is not available for a particular electronic device. For example, a data collector may be recently initiated on an electronic device. In this example, the electronic device state may not be able to be predicted until the data collector is able to collect six months' worth of usage data.

Moreover, at the point that the data collector begins to collect data, the electronic device may have already had use. This use may influence the state of the electronic device, but for which there is no recorded data. Put another way, data collection may begin when a data collector is initialized on the electronic device. If an electronic device is older, but the data collector is recently initialized, there is less usage data from which a prediction may be made, and collected usage data since the initialization of the electronic device may not paint an accurate picture as it does not account for usage of the electronic device before the point in time the data collector began collecting data.

Accordingly, the present specification describes a system which collects data for a certain period of time and then extrapolates usage data for a longer period of time, such that an accurate prediction of state may be made more quickly and more accurately. For example, a system may initiate a data collector, which collects usage data relating to processor usage, application execution, application performance and may also collect data indicative of hardware component state and abnormalities in electronic device operation. A model generator then performs analytics on this information, in some cases using historic data from other devices and/or machine-learning training sets, to predict the health of the electronic device and to provide recommendations on preventative action that can alleviate the undesirable circumstances that may arise when a hardware component unexpectedly fails. As a particular example, the data collector may indicate that a particular electronic device relies heavily on alternating current (AC) power and as a preventative action, recommends, or changes, certain settings to increase the life of the battery.

Such a predictive model generation is based on the concept that electronic device usage follows certain patterns over periods of time. For example, an electronic device user may use the electronic device for a certain duration in a day and may execute certain applications over that duration. Based on these patterns of collected usage data, behavior over a longer duration can be extrapolated, in other words, usage data is backward forecasted to obtain a desired amount of usage data to ensure an accurate prediction of the electronic device state. As such, the system enables the prediction of electronic device health for electronic devices for which there is not a desired amount of usage data. As a particular example, collected usage data may span a two-week period, whereas a desired amount, and therefore extrapolated amount, of usage data may be six months.

Specifically, the present specification describes a system. The system includes a data collector to collect usage data for the electronic device over a first period of time. The system also includes a model generator. The model generator extrapolates usage data for the electronic device over a second period of time that is longer than the first period of time and predicts a state of the electronic device based on extrapolated usage data for the electronic device over the second period of time.

The present specification also describes a method. According to the method, usage data for an electronic device is collected over a first period of time. Based on the usage data over the first period of time, usage data over a second period of time, which is longer than the first period of time, is extrapolated. Based on the extrapolated usage data over the second period of time, a state of the electronic device is determined. In an example, the system provides a recommended action to execute at the electronic device based on a determined state of the electronic device.

The present specification also describes a non-transitory machine-readable storage medium encoded with instructions executable by a processor of an electronic device. The instructions, when executed by the processor, cause the processor to 1) collect usage data for the electronic device over a first period of time, 2) extrapolate, based on the usage data over the first period of time, usage data over a second period of time that is longer than the first period of time, and 3) determine a current state of the electronic device based on extrapolated usage data. The instructions are also executable by the processor, to cause the processor to predict a health metric for the electronic device based on the current state and provide a recommendation on an action to execute at the electronic device based on a predicted health metric

In summary, such a system, method, and machine-readable storage medium may, for example 1) predict electronic device state and/or health metrics for electronic devices for which there is not enough usage data available to make an accurate prediction; 2) identify circumstances which may be undetected due to a lack of available collected usage data; 3) identify anomalous electronic device conditions; and 4) benchmark electronic device performance. However, it is contemplated that the devices disclosed herein may address other matters and deficiencies in a number of technical areas, for example.

As used in the present specification and in the appended claims, the term “a number of” or similar language is meant to be understood broadly as any positive number including 1 to infinity.

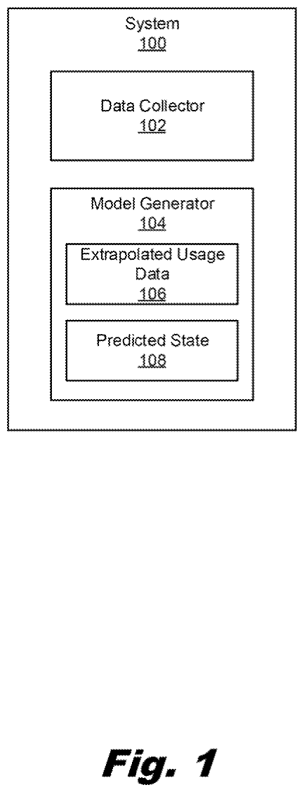

Turning now to the figures, FIG. 1 is a block diagram of a system (100) for extrapolating usage data for an electronic device, according to an example of the principles described herein. The system (100) may be installed on an electronic device which may be of a variety of types including a desktop computer, a laptop computer, a thin client, a server, an all-in-one device, a tablet, a smart phone, or any of a variety of other electronic devices.

The system (100) may include a data collector (102) to collect usage data for the electronic device over a first period of time. As described above, an electronic device may include any number of hardware components, and the usage or state of those hardware components may be indicative of a state, or health, of the electronic device in which they are installed. For example, the more that an electronic device is used, the greater the wear imposed on the central processing unit (CPU), which wear affects the operational life of the hardware component and the electronic device as well. As such, the data collector (102) collects usage data for the electronic device.

The types of data that may be collected may vary. In general, the usage data is data indicative of use of hardware components and/or executable code executed on the electronic device. For example, the usage data may include processor usage, as specific examples central processing unit (CPU) usage and graphics processing unit (GPU) usage. Other examples of hardware components that are monitored include the battery and network adapters.

Other examples of usage data that may be collected include the applications that are executed on the electronic device as well as usage rates and performance of the applications. For example, the data collector (102) may determine which applications are run, the amount of time that each application is run, and timestamps associated with the use of such applications.

Further examples include a state of various hardware devices such as hard drives, batteries, processors, fans, cooling systems, and memory devices. That is, each of these devices may have states indicative of their performance. The data collector (102) may identify these states and may also monitor the usage of each component.

Other examples of data that may be collected include an age of the hardware components and/or executable program instructions. Again, the age of these components may be indicative of their anticipated failure, whether scheduled maintenance should be performed, and/or whether or not they are outdated. Such state information may also indicate a model and/or version number, which may be used to indicate whether the hardware component should be updated.

As yet another example, login time stamps and logout time stamps may be indicative of electronic device and hardware component usage. For example, login and logout time stamp information may indicate that the electronic device is active during certain periods of time for different days. Such information is predictive of a state and/or health of the electronic device.

As yet another example, anomalous operation of the electronic device, for example improperly executed operations and operating system (OS) crashes may be tracked by the data collector (102). As yet another example, an operating system start up time may be tracked and used to predict the state of the electronic device. While particular reference is made to specific usage data that is collected, the data collector (102) may collect any variety of information from the hardware components of the electronic device, which information is indicative of a state, or health, of the electronic device.

As yet another example, the data collector (102) may include a temperature monitor to monitor the thermal states within the electronic device, either of the electronic device itself or different components such as the battery. That is, it may be the case that the thermal state of the electronic device and the hardware components, may be indicative of the age and state of the hardware components. While particular reference is made to certain data that is collected regarding the hardware component and/or electronic device usage, other information may be similarly collected.

As such, the data collector (102) may include a processor, an application-specific integrated circuit (ASIC), a semiconductor-based microprocessor, a central processing unit (CPU), and a field-programmable gate array (FPGA), and/or other hardware device and memory.

The memory may include a machine-readable storage medium, which machine-readable storage medium may contain, or store computer-usable program code for use by or in connection with an instruction execution system, apparatus, or device. The memory may include many types of memory including volatile and non-volatile memory. For example, the memory may include Random Access Memory (RAM), Read Only Memory (ROM), optical memory disks, and magnetic disks, among others. The executable code may, when executed by the respective component, cause the component to implement the functionality described herein.

After the data collector (102) has collected usage data for the first period of time, the model generator (104) of the system (100) may extrapolate usage data (106) for the electronic device over a second period of time, which second period of time is longer than the first. For example, the second period of time may be ten times longer than the first period of time. As a specific example, usage data may be collected over a 2-week period of time, and the model generator (104) may extrapolate the usage data to result in extrapolated usage data (106) over a 6-month period of time.

The model generator (104) may produce the extrapolated usage data (106) in a variety of ways. For example, the model generator (104) may linearly extrapolate the observed usage data from the first period of time to the second period of time. As an example, the model generator (104) may determine that from observed usage data indicating 45 hours of CPU usage over the 2-week period, that the CPU has a usage of 540 hours over the 6-month period. While this is a simplified example, usage data for the variety of other categories described above, as well as others, may be linearly extrapolated from the first period of time to the second period of time.

In another example, the model generator (104) may produce the extrapolated usage data (106) based on observed usage data from a similar electronic device. For example, a first electronic device and a second electronic device may have similar observed usage data over the first period of time, i.e., the 2-week interval. In this example, the second electronic device may have additional observed usage data spanning the second period of time, i.e., the 6-month interval and potentially for an even longer period of time. In this example, based on the similarity between the 2-week usage data for the first and second electronic devices, the model generator (104) may replicate the 6-month observed usage data from the second electronic device as extrapolated usage data (106) for the first electronic device.

As yet another example, the model generator (104) may be a machine-learning model generator which relies on a training set to produce the extrapolated usage data (106). That is, the training set may include information collected from tens, hundreds, or thousands of electronic devices. The model generator (104) may compile that observed usage data and predict, based on patterns in the shorter duration observed usage information from the electronic device, the extrapolated usage data (106) over the 6-month period.

Using whatever method, the model generator (104) may predict a state (108) of the electronic device based on the extrapolated usage data (106) for the electronic device over the second period of time. In an example, the state may be indicative of the health of the electronic device. For example, the age and/or usage of the CPU may indicate that the CPU is at a certain stage along its operational life, which stage may be different based on the usage of the CPU. As such, the model generator (104) provides a snapshot of the various hardware components and executable instructions at the electronic device in order to provide a recommended action, such as repairing, replacing, and/or updating the hardware component.

As a particular example, the model generator (104) may determine that a battery is at a certain stage of swell, such that it may be time to replace the battery. As another example, it may be that a particular processor or other hardware component is highly utilized based on particular applications that are run. For example, a GPU may have a high utilization state (108) which is indicated by extrapolated usage data (106) indicating high use of a video rendering application. Responsive to this predicted state (106) of high GPU utilization, the system (100) may recommend upgrading the GPU to ensure more accurate and efficient execution of the highly utilized video rendering application. Moreover, the system (100) may recommend enhanced virus protection as over utilization of certain hardware components may pose a security threat.

As yet other examples of a predicted state (108) and recommended actions, the model generator (104) may identify that certain applications are crashing when another application is executed and may provide a notice of such to an administrator and/or may prevent concurrent execution of the applications that resulted in the crash.

As yet another example, the data collector (102) may determine a version or model of a particular hardware component, and the model generator (104) may determine that the component is outdated. As such, the system (100) may recommend an upgrade to the hardware component and/or the program instructions to operate the hardware component. While specific reference is made to particular remedial actions and predicted states (108), the model generator (104) may identify different predicted states (108), each of which may trigger a particular remedial action.

As such, the model generator (104)) may include a processor, an application-specific integrated circuit (ASIC), a semiconductor-based microprocessor, a central processing unit (CPU), and a field-programmable gate array (FPGA), and/or other hardware device and memory.

The memory may include a computer-readable storage medium, which computer-readable storage medium may contain, or store computer-usable program code for use by or in connection with an instruction execution system, apparatus, or device. The memory may include many types of memory including volatile and non-volatile memory. For example, the memory may include Random Access Memory (RAM), Read Only Memory (ROM), optical memory disks, and magnetic disks, among others. The executable code may, when executed by the respective component, cause the component to implement the functionality described herein.

Accordingly, the present system (100) generates metrics related to electronic device health and from which predictions about future conditions and/or failures may be made. As in the specific example of battery swell, without such a system (100), swollen batteries may go undetected due to a lack of usage data to diagnose battery swell. Using the present system (100), historical usage of the battery and other hardware components is backwards forecasted such that conditions, such as battery swell and others, may be detected.

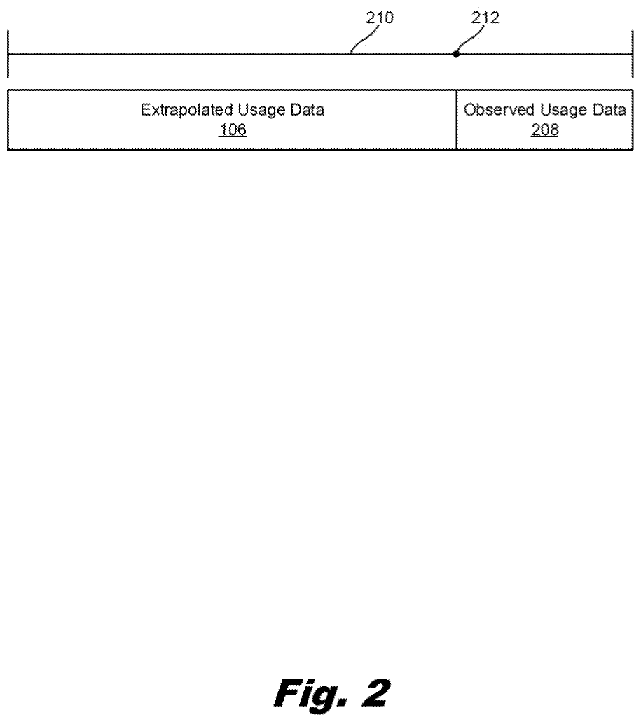

FIG. 2 illustrates, usage data (106) extrapolated based on observed usage data (208), according to an example of the principles described herein. In the example depicted in FIG. 2, the electronic device may have an operational life indicated by the line (210). In this example, at a point in time (212) a data collector (FIG. 1, 102) may have started collecting usage data such that for the first period of time there is observed usage data (208), However, in order to make an accurate prediction of device state or health and to make recommendations on preventative actions to execute, additional usage data may be desired. Accordingly, as noted above, the model generator (FIG. 1, 104) may extrapolate usage data (106), such that a more accurate and reliable prediction of the state and/or health of the electronic device may be made. That is, such a system (FIG. 1, 100) extrapolates usage data which was not recorded prior to the data collector (FIG. 1, 102) observing usage data.

As described above, the data collector (FIG. 1, 102) may collect a variety of types of usage data relating to hardware and program instruction usage. Such usage data includes, but is not limited to applications used, battery usage patterns, and overall electronic device usage, etc. among others. Relying on such observed and extrapolated usage data (106), the model generator (FIG. 1, 104) can determine health metrics related to hardware components such as the hard drive, battery, CPU, and others. The model generator (FIG. 1, 104) may also make predictions about the electronic device future health. For example, to determine when a battery is likely to wear out.

As such, predictions and recommendations are made, even though the data collector (FIG. 1, 102) may have collected data for shorter than desired for an accurate prediction. That is, health metrics may not be able to be reliably calculated based on 2-week usage data. However, extrapolated usage data (106) may span six months, which provides for the desired time frame to make an accurate prediction.

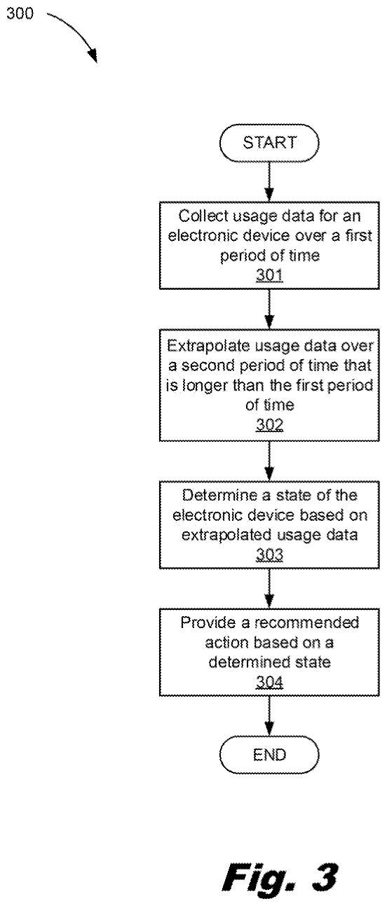

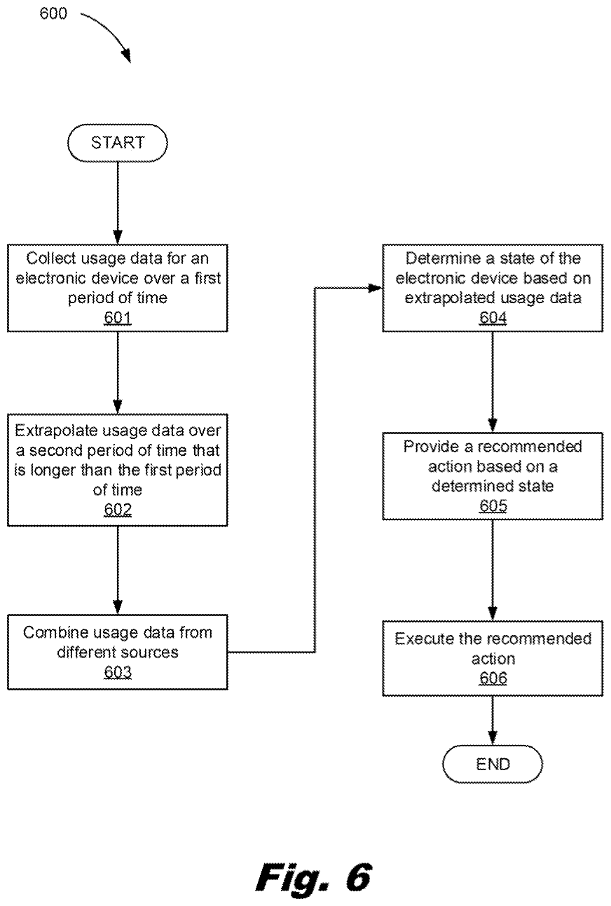

FIG. 3 is a flowchart of a method (300) for extrapolating usage data (FIG. 1, 106), according to an example of the principles described herein. According to the method (300), usage data is collected (block 301) for an electronic device over a first period of time. As described above, the first period of time may be shorter than desired for an accurate or reliable prediction of health. Also as described above, the data collector (FIG. 1, 102) may collect a variety of types of information that relate to the hardware component usage, executable program instruction usage, and/or electronic device state. Based on the usage data over the first period of time, the model generator (FIG. 1, 104) may extrapolate (block 302) usage data over a second period of time, which is longer than the first period of time. As described above, this may be done in a number of ways. For example, the model generator (FIG. 1, 104) may linearly extrapolate the usage data over the first period of time to extend to the second period of time. For example, the second period of time may be a factor greater than the first period of time. In this example, the model generator (FIG. 1, 104) may generate the extrapolated usage data (FIG. 1, 106) by multiplying the observed usage data (FIG. 2, 208) by the same factor. In other examples, the model generator (FIG. 1, 104) may use machine-learning or a similarity metric with other electronic device usage data to extrapolate (block 302) the usage data. In some examples, the model generator (FIG. 1, 104) may implement multiple methods and then combine the results. Additional information is provided in connection with FIG. 6.

With the usage data extrapolated (block 302) over the second period of time, the model generator (FIG. 1, 104) may determine (block 303) a state of the electronic device based on extrapolated usage data. That is, as described above, usage data may be indicative of a state or health of the hardware components for which usage data is collected and/or the electronic device in general. In addition to indicating a state of the electronic device, the system (FIG. 1, 100) may provide (block 304) a recommended action based on the determined state. For example, the recommendation may be to update a hardware component. The recommendation may be to replace or repair a hardware component. In other examples, the recommendation may be to further inspect the hardware component, or run a diagnostic test for the hardware component to further assess its functionality. While particular reference is made to particular recommended actions, a variety of preventative remedial actions may be recommended.

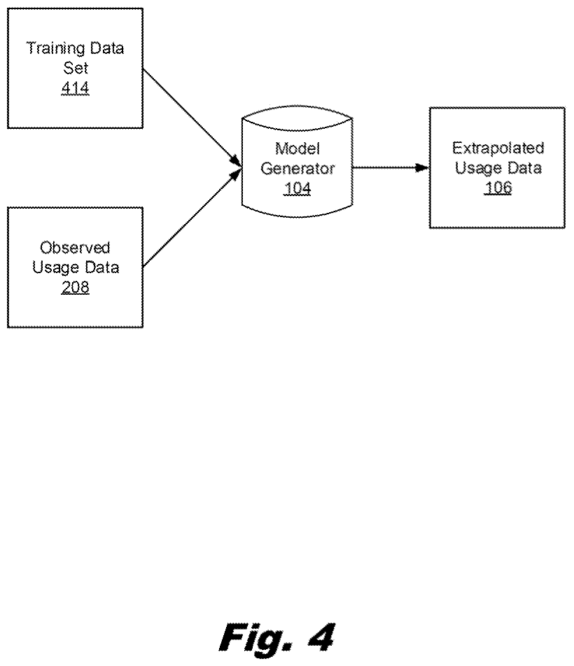

FIG. 4 is a diagram of a system (FIG. 1, 100) for extrapolating usage data, according to an example of the principles described herein. In some examples, the model generator (104) is a machine-learning model generator (104) which extrapolates usage data for the electronic device over the second period of time based on a training set. That is, the data collector (FIG. 1, 102) on different electronic devices may collect usage data such as how many hours the electronic devices are turned on daily and weekly, and bi-monthly. The data collector (FIG. 1, 102) may also collect any of the above-mentioned hardware component usage data, or other hardware component usage data from the different electronic devices. This corpus of information may be referred to as a training data set (414) and may guide the model generator (104) in identifying patterns of usage. That is, the model generator (104) may identify patterns in the training set of usage data, which training set includes observed usage data from multiple, for examples tens or hundreds, of electronic devices, over at least the second period of time. For example, the machine-learning model generator (104) may use random forest linear regression to identify the patterns. While particular reference is made to a particular machine learning methodology, other types of machine learning model generators (104) may be implemented which utilize different machine learning methods. Other examples include K-nearest neighbor, support vector machine, Naïve Bayes, and logistic regression among others. Note that the machine-learning model generator (104) may be dynamic. That is, the training data set (414) may be a dynamic training set with additional data points continuously added and analyzed so that more accurate patterns may be identified.

In this example, the model generator (104) also receives observed usage data (208) from the target electronic device. With both of these inputs, i.e., the training set data (414) collected from multiple electronic devices and the observed usage data (208) from the target electronic device, the model generator (104) may generate the extrapolated historical usage data (106) for the target electronic device for the second period of time which is longer than the first period of time for which observed usage data (208) is collected. Specifically, based on similar patterns between first period usage data from the training data set (414) and first period observed usage data (208), the machine-learning model generator (104) may identify similar patterns between the two and identify, from the training data set (414), usage data over the second period of time to apply to the electronic device as extrapolated usage data (106).

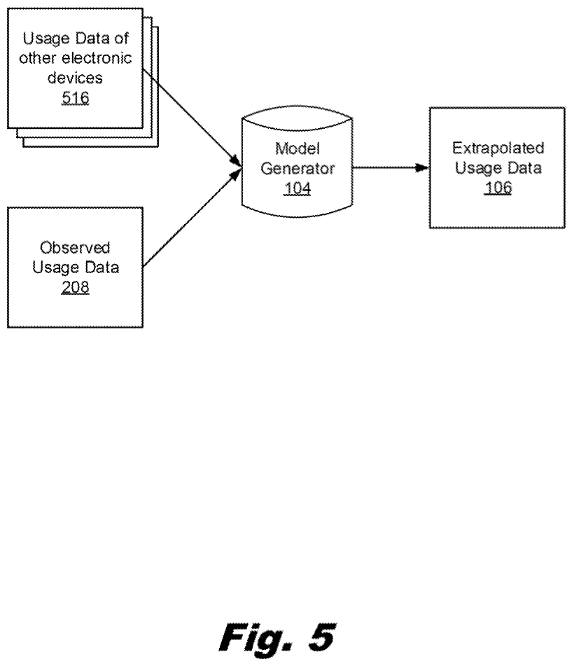

FIG. 5 is a diagram of a system (FIG. 1, 100) for extrapolating usage data, according to an example of the principles described herein. In the example depicted in FIG. 5, the model generator (104) generates extrapolated usage data (106) by identifying observed usage data over the first period of time from another electronic device that is similar to the observed usage data (208) from the target electronic device. The other electronic device may also have observed usage data over a 6-month period of time. That is, if an electronic device with similar 2-week usage data as the target electronic device is identified, and for which there is 6-month usage data, the 6-month usage data may be replicated from the second electronic device to the target electronic device.

As such, in this example, the model generator (104) receives usage data (516) of other electronic devices, which usage data spans at least the second period of time. The model generator (104) may calculate a first period similarity metric between the electronic device and multiple other electronic devices for which there is collected, and not extrapolated, usage data over the second period of time. As an example, criteria including geographic location, similar login and logout time stamps, similar used applications, etc., may be determined for each electronic device and a Euclidean distance calculated between usage data of the target electronic device and each other electronic device for which there is collected usage data.

From among the multiple other electronic devices, a neighbor, or other, electronic device with usage data over the first period of time that is closest to the usage data over the first period of time for the electronic device is identified. That is, the other electronic device with the smallest Euclidean distance of usage data may be identified as an electronic device for which the usage data is to be replicated. In this example, the model generator (104) then extrapolates the usage data by replicating the usage data over the second period of time for the neighbor electronic device as the extrapolated usage data (FIG. 1, 106) over the second period of time for the electronic device.

As a particular example, observed usage data (208) for the target electronic device may indicate the CPU usage as 45 hours over a 2-week period. A neighbor electronic device for which there was also 45 hours over a 2-week period may have observed usage data indicating CPU usage as 600 hours over a 6-month period. In this example, the 600-hour usage rate from the neighbor electronic device may be replicated at the target electronic device. Accordingly, the model generator (104) may predict a state of the target electronic device based on a predicted 600-hour usage of the CPU of the target electronic device.

As another example, a target electronic device may have the following two-week usage data: ten hours coupled to an alternating current (AC) adapter; 80% average CPU utilization, two hours usage of a particular data visualization application, and eight hours usage of a word processing application. From the usage data (516) of other electronic devices a first candidate device, Device A, may have the following two-week collected usage data: eleven hours coupled to an AC adapter: 75% average CPU utilization; one and a half hours usage of the particular data visualization application, and seven hours usage of the word processing application. Similarly, from the usage data (516) of other electronic devices a second candidate device, Device B, may have the following two-week collected usage data: eight hours coupled to an AC adapter; 60% average CPU utilization; one and a half hours usage of a video rendering application, and seven hours usage of the word processing application. In this example, both Device A and Device B have 6-month collected usage data. From this information, the model generator (104) may select Device A as the neighbor electronic device and utilize the 6-month usage data from Device A as the extrapolated usage data (106) for the target electronic device.

In an example, the model generator (104) may alter the extrapolated usage data for the electronic device over the second period of time based on a difference between the usage device for the electronic device and the usage data for the neighbor electronic device. For example, it may not be, the case that the 2-week usage data is the same. For example, the CPU usage for the target electronic device may be 45 hours, while the CPU usage of the neighbor electronic device (i.e., that electronic device with the smallest Euclidean distance between usage data), may be 48 hours. In this example, the model generator (104) may alter the 600-hour 6-month usage data to be 580-hours for the target electronic device based on the difference in the 2-week value.

FIG. 6 is a flowchart of a method (600) for extrapolating usage data, according to an example of the principles described herein. As described above, usage data is collected (block 601) for an electronic device over a first period of time and usage data is extrapolated (block 602) for the electronic device over a second period of time that is longer than the first period of time. As described above, such extrapolation may include a linear extrapolation of the usage data over the first period of time, usage data over the second period of time replicated from a neighbor electronic device, or usage data over the second period of time from a training set of a machine-learning model generator (FIG. 1, 104). These may be performed as described above in connection with FIG. 3.

In some examples, the collected data is determined from cumulative information. For example, certain hardware component usage information may be cumulative such as total hours on AC or total time for a certain application. In this example, the cumulative information is averaged over a certain time period to determine weekly, monthly, or daily usage based on the cumulative values.

In some examples, the extrapolated data may be from multiple sources. For example, the model generator (FIG. 1, 104) may collect usage data from a neighbor electronic device as well as the training set. In this example, the model generator (FIG. 1, 104) may combine usage data from the different sources. For example, a neighbor electronic device may have collected usage data over the 6-month period indicating 600 hours of CPU usage and a training set may recommend 580 hours of CPU usage based on the observed 2-week usage data for the electronic device. In this example, the model generator (FIG. 1, 104) may combine these two values, for example by averaging them, to determine the extrapolated usage data for the electronic device to be 590 hours. While specific reference is made to a particular way to combine the collected usage data over the second period of time in determining the extrapolated usage time for the electronic device, the model generator (FIG. 1, 104) may combine the usage time from the different sources in different ways. For example, the model generator (FIG. 1, 104) may weight the usage data from the different sources, for example by giving a higher weight to the training set/machine learning data as compared to the usage data from a neighbor electronic device. In other examples, the collected usage data and/or the extrapolated usage data may be adjusted to remove error from the data sets.

According to the method (600), a state of the electronic device is determined (block 604) and a recommended action is provided (block 605) based on the determined state. These operations may be performed as described above in connection with FIG. 3.

In addition to providing (block 605) a recommended preventative action, in this example, the method (600) may include executing (block 606) the recommended action at the electronic device. For example, if it is determined that a hardware component executable instruction set is outdated, the system (FIG. 1, 100) may operate to acquire updated program instructions and install them at the electronic device. While particular reference is made to a certain recommended action, other recommended actions may be executed (block 606).

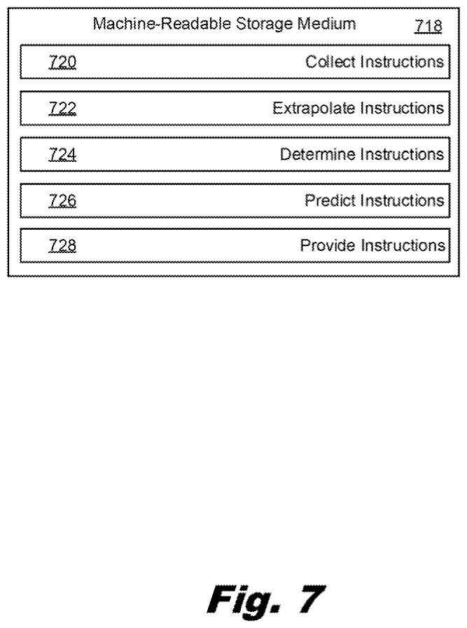

FIG. 7 depicts a non-transitory machine-readable storage medium (718) for extrapolating usage data, according to an example of the principles described herein. To achieve its desired functionality, the system (FIG. 1, 100) includes various hardware components. Specifically, the system (FIG. 1, 100) includes a processor and a machine-readable storage medium (718). The machine-readable storage medium (718) is communicatively coupled to the processor. The machine-readable storage medium (718) includes a number of instructions (720, 722, 724, 726, 728) for performing a designated function. In some examples, the instructions may be machine code and/or script code.

The machine-readable storage medium (718) causes the processor to execute the designated function of the instructions (720, 722, 724, 726, 728). The machine-readable storage medium (718) can store data, programs, instructions, or any other machine-readable data that can be utilized to operate the system (FIG. 1, 100). Machine-readable storage medium (718) can store machine readable instructions that the processor of the system (FIG. 1, 100) can process, or execute. The machine-readable storage medium (718) can be an electronic, magnetic, optical, or other physical storage device that contains or stores executable instructions. Machine-readable storage medium (718) may be, for example, Random-Access Memory (RAM), an Electrically Erasable Programmable Read-Only Memory (EEPROM), a storage device, an optical disc, etc. The machine-readable storage medium (716) may be a non-transitory machine-readable storage medium (718).

Referring to FIG. 7, collect instructions (720), when executed by the processor, cause the processor to, collect usage data for the electronic device over a first period of time. Extrapolate instructions (722), when executed by the processor, cause the processor to, extrapolate, based on the usage data over the first period of time, usage data over a second period of time that is longer than the first period of time, Determine instructions (724), when executed by the processor, cause the processor to determine a current state of the electronic device based on extrapolated usage data. Predict instructions (726), when executed by the processor, also cause the processor to, predict a health metric for the electronic device based on the current state. Provide instructions (728), when executed by the processor, also cause the processor to, provide a recommendation on an action to execute at the electronic device based on a predicted health metric.

In summary, such a system, method, and machine-readable storage medium may, for example 1) predict electronic device state and/or health metrics for electronic devices for which there is not enough usage data available to make an accurate prediction; 2) identify circumstances which may be undetected due to a lack of available collected usage data; 3) identify anomalous electronic device conditions; and 4) benchmark electronic device performance. However, it is contemplated that the devices disclosed herein may address other matters and deficiencies in a number of technical areas, for example

What is claimed is:

1. A system, comprising:
a data collector to collect usage data for an electronic device over a first period of time; and
a model generator to:
extrapolate usage data for the electronic device over a second period of time that is longer than the first period of time; and
predict a state of the electronic device based on extrapolated usage data for the electronic device over the second period of time.

2. The system of claim 1, wherein the usage data is selected from the group consisting of:
processor usage;
applications executed;
application usage;
battery state;
electronic device state;
hard drive state;
thermal state;
anomalous operation of the electronic device;
login time stamps; and
logout time stamps.

3. The system of claim 1, wherein the model generator is to extrapolate usage data for the electronic device over the second period of time by performing a linear extrapolation of the usage data collected over the first period of time.

4. The system of claim 1, wherein the model generator is to extrapolate usage data for the electronic device over the second period of time by:
calculating a first period similarity metric between the electronic device and multiple other electronic devices wherein each of the multiple other electronic devices have usage data over the second period of time;
identifying from among the multiple other electronic devices, a neighbor electronic device with usage data over the first period of time that is closest to the usage data over the first period of time for the electronic device; and
replicating the usage data over the second period of time for the neighbor electronic device as the usage data over the second period of time for the electronic device.

5. The system of claim 4, wherein the model generator is to alter the extrapolated usage data for the electronic device over the second period of time based on a difference between the usage data for the electronic device and the usage data for the neighbor electronic device.

6. The system of claim 1, wherein:
the model generator is a machine-learning model generator which is to extrapolate usage data for the electronic device over the second period of time by:
identifying patterns in a training set of usage data over the second period of time for multiple electronic devices; and
extrapolating the usage data over the second period of time for the electronic device based on the usage data for the electronic device over the first period of time and the training set of usage data over the second period of time.

7. The system of claim 1, wherein the state of the electronic device indicates a heath of the electronic device.

8. A method, comprising:
collecting usage data for an electronic device over a first period of time;
extrapolating, based on the usage data over the first period of time, usage data over a second period of time that is longer than the first period of time;
determining, based on extrapolated usage data over the second period of time, a state of the electronic device; and
providing a recommended action to execute at the electronic device based on a determined state of the electronic device.

9. The method of claim 8, further comprising executing a recommended action at the electronic device.

10. The method of claim 8, wherein extrapolated usage data over the second period of time is sourced from multiple of:
a linear extrapolation of the usage data over the first period of time;
usage data over the second period of time from another electronic device; and
usage data over the second period of time from a training set of a machine-learning model generator.

11. The method of claim 10, further comprising combining usage data from different sources.

12. The method of claim 11, further comprising weighting usage data from different sources.

13. The method of claim 10, further comprising averaging usage data from different sources.

14. A non-transitory machine-readable storage medium encoded with instructions executable by a processor of an electronic device to, when executed by the processor, cause the processor to:
collect usage data for the electronic device over a first period of time;
extrapolate, based on the usage data over the first period of time, usage data over a second period of time that is longer than the first period of time;
determine a current state of the electronic device based on extrapolated usage data;
predict a health metric for the electronic device based on the current state; and
provide a recommendation on an action to execute at the electronic device based on a predicted health metric

15. The non-transitory machine-readable storage medium of claim 14, wherein the second period of time is ten times longer than the first period of time.
